(19) United States
(12) Patent Application Publication
(10) Pub. No.: US 2015/0261411 A1
(43) Pub. Date: Sep. 17, 2015

(54) DISPLAYING COLLABORATION ICONS FOR COLLABORATION STATES

(71) Applicant: MICROSOFT CORPORATION, Redmond, WA (US)

(72) Inventors: Derek Snook, Redmond, WA (US); Cindy Liao Hartwig, Sammamish, WA (US); Bart Chellis, Kirkland, WA (US); Yanling Wang, Belmont, CA (US); Ying Huang, Bellevue, WA (US)

(21) Appl. No.: 14/217,118

(22) Filed: Mar. 17, 2014

(51) Int. Cl. G06F 3/0481; G06F 3/0484

(52) U.S. Cl. CPC G06F 3/04817; G06F 3/04842

(57) ABSTRACT

A collaboration icon system displays collaboration icons representing a current collaboration state of a resource. The collaboration icon system determines the collaboration state of the resource. When the collaboration state indicates that the resource does not have multiple editors, the collaboration icon system displays a share icon that is selectable to support sharing the resource. When the collaboration state indicates that the resource has multiple editors, the collaboration icon system displays an editors icon to support sharing the resource and accessing information relating to the editors. The share icon and the editors icon provide an indication of the collaboration state while the resource is being accessed.

### BACKGROUND

Document collaboration systems allow multiple collaborators (e.g., users or authors) to work collaboratively on a resource such as a document or database. A document collaboration system may support single editor mode or multiple editor mode. With single editor mode, only one collaborator is allowed to edit a document at a time. To edit a document, a collaborator checks out a document from the document collaboration system, edits the document, and checks the edited document back into the document collaboration system. If another collaborator attempts to check out the document while it is currently checked out, the document collaboration system prevents that check out until the document is checked back in. With multiple editor mode, multiple collaborators are allowed to edit a document at the same time. To edit a document, each collaborator can check out (or open) the document for editing at any time. Thus, multiple collaborators can have the document checked out at the same time. A collaborator who has a document open for editing is referred to as an editor. A document collaboration system may use various techniques to prevent or resolve conflicts in the editing process. For example, a document collaboration system may lock a paragraph that is currently being edited by one editor so that other editors cannot edit that paragraph until it is unlocked. As another example, a document collaboration system may employ various rules to resolve conflicts in the editing after each editor completes an editing session and checks the document back into the document collaboration system.

When a document is created, its author may designate users who can share the document. The author may register the names of those users with the document collaboration system along with their access rights. For example, a user may have access to a document in read-only mode, and another user may have access to the same document in read-write mode. The users with access in read-write mode would be considered collaborators. The author may also send a link to the document to another user. Using a link implies that the user is also considered collaborator on that document. When a collaborator opens the document for editing, the collaborator is considered an editor becuase the collaborator is currently editing the document.

Various techniques have been employed to provide information regarding collaborators and editors of opened documents. These techniques, however, may not provide the information in an intuitive or user-friendly manner, especially when the information is provided on a device the supports a touchscreen display.

### SUMMARY

In some embodiments, a collaboration icon system displays collaboration icons representing a current collaboration state of a resource. The collaboration icon system determines the collaboration state of the resource. When the collaboration state indicates that the resource does not have multiple editors, the collaboration icon system displays a share icon that is selectable to support sharing the resource. When the collaboration state indicates that the resource has multiple editors, the collaboration icon system displays an editors icon to support sharing the resource and accessing information relating to the editors. The share icon and the editors icon provide an indication of the collaboration state while the resource is being accessed.

### BRIEF DESCRIPTION OF THE DRAWINGS

FIG. 1 is a display page that illustrates the display of a share icon in some embodiments.

FIG. 2 is a display page that illustrates functionality provided when the share icon is selected in some embodiments.

FIG. 3 is a display page that illustrates the display of a collaborators icon in some embodiments.

FIG. 4 is a display page that illustrates functionality provided when a collaborators icon is selected in some embodiments.

FIG. 5 is a display page that illustrates display of an editors icon in some embodiments.

FIG. 6 is a display page that illustrates functionality provided when the editors icon is selected.

FIG. 7 illustrates state diagram for a collaboration state that has two possible states in some embodiments.

FIG. 8 illustrates a state diagram for a collaboration state that has three possible states in some embodiments.

FIG. 9 is a block diagram that illustrates components of a collaboration icon system in some embodiments.

FIG. 10 is a flow diagram that illustrates the processing of an open document component of the collaboration icon system in some embodiments.

FIG. 11 is a flow diagram that illustrates the processing of a display collaboration icon of the collaboration icon system in some embodiments.

FIG. 12 is a flow diagram that illustrates the processing of a receive share notification component of the collaboration icon system in some embodiments.

FIG. 13 is a flow diagram that illustrates the processing of a close document component of the collaboration icon system in some embodiments.

### DETAILED DESCRIPTION

A method and system for indicating a collaboration state of a resource is provided. In some embodiments, a collaboration icon system displays a collaboration icon that can be either a share icon or an editors icon based on, and associated with, the current collaboration state of the resource. The collaboration state indicates whether the resource has multiple editors with a no multiple editors state and a multiple editors state. When the collaboration state indicates that the resource is not opened by multiple collaborators (Le., in the no multiple editors state), the collaboration icon system displays the share icon to suggest that the icon can be selected in order to share the resource with collaborators. When the collaboration state indicates that the resource is opened by multiple collaborators (i.e., in the multiple editors state), the collaboration icon system displays the editors icon. When the collaboration state changes while a resource is open, the collaboration icon system replaces the currently displayed collaboration icon with the icon associated with the new collaboration state. For example, when the collaboration state changes from the no multiple editors state to the multiple editors state, the collaboration icon system replaces the share icon with the editors icon. The share icon and the editors icon are selectable to provide additional functionality. When the share icon is selected, the collaboration icon system provides support for sharing the resource. For example, the collaboration icon system may display a menu that includes a menu item for sending a link to the resource to another user so that the document can be shared with that user. When the editors icon is selected, the collaboration icon system provides support for sharing the resource and access to information relating to the editors. The collaboration icon represented as a share icon and an editors icon provides a persistent indication of the collaboration state of a resource while the resource is open and at a consistent location on a display.

In some embodiments, the share icon and the editors icon suggest the capability of document collaboration and convey more information about the collaboration than just the collaboration state. The share icon and the editors icon may be in a shape that suggests a person to indicate that the icon stands for collaboration with an other user. For example, the icons may be in the general shape of the head and shoulders of a person, referred to -s a pawn icon or pawn shape. The share icon and the editors icon may be the same shape overall where the share icon is unshaded and the editors icon is shaded to distinguish between no multiple editors and multiple editors. The share icon may include a plus sign “+” to further suggest that the icon can be selected in order to share the document with others. The editors icon may include a number indicating the number of editors.

In some embodiments, the collaboration icon system may use an additional collaboration state to distinguish whether a resource with no other editors has been shared with collaborators. This additional collaboration state results in the three states of 1) not shared, 2) shared but without multiple editors, and 3) multiple editors. The collaboration icon system may display a share icon, a collaborators icon, and an editors icon for each of these states, respectively. When the share icon and the editors icon are selected, the collaboration icon system may provide additional functionality as described above. When the collaborators icon is selected, the collaboration icon system may provide support for sharing the resource and access to information relating to the collaborators. The collaborators icon may suggest multiple people with a plus sign to suggest that the icon can be selected to share with others. Alternatively, the collaborators icon may be similar to the share icon except with a number in place of the plus sign to indicate the number of collaborators.

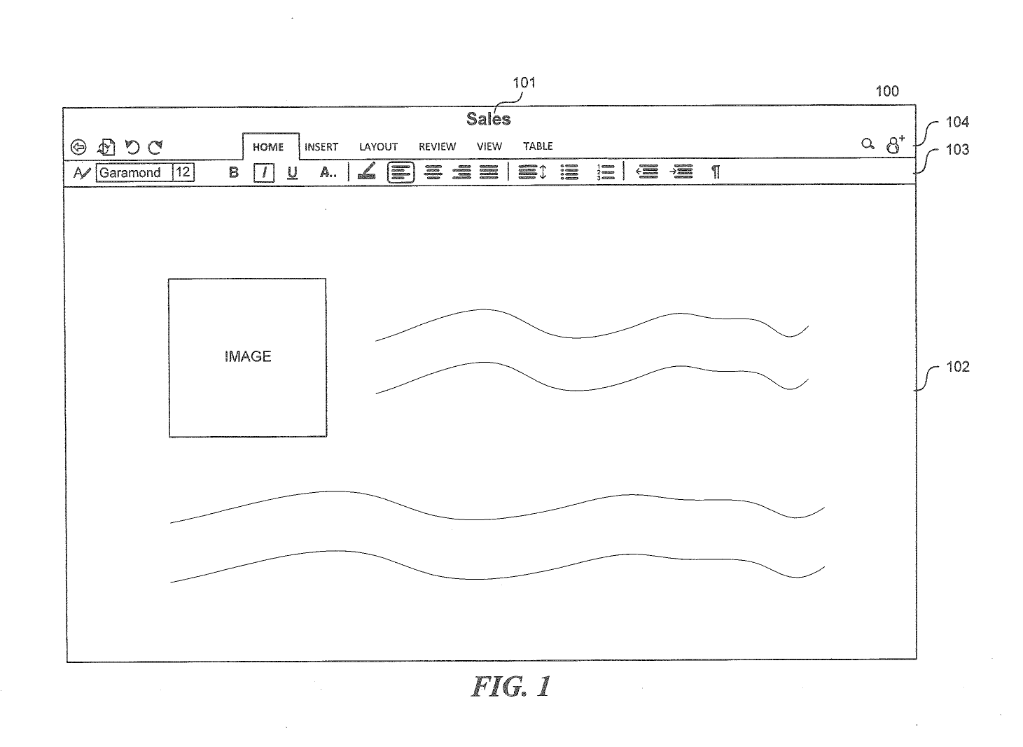

FIG. 1 is a display page that illustrates the display of a share icon in some embodiments. A display page 100 includes a name area 101, a content area 102, a ribbon area 103, and a collaboration icon area 104. The name area 101 includes the name of the currently opened document, and the content area 102 contains the content of that document. The ribbon area 103 provides access to various tabs with associated functionality. The collaboration icon area 104 displays a collaboration icon depending on the current collaboration state. The collaboration icon area 104 currently displays a share icon indicating that the currently open document is not shared with collaborator. The share icon is illustrated as an unshaded pawn with a plus sign.

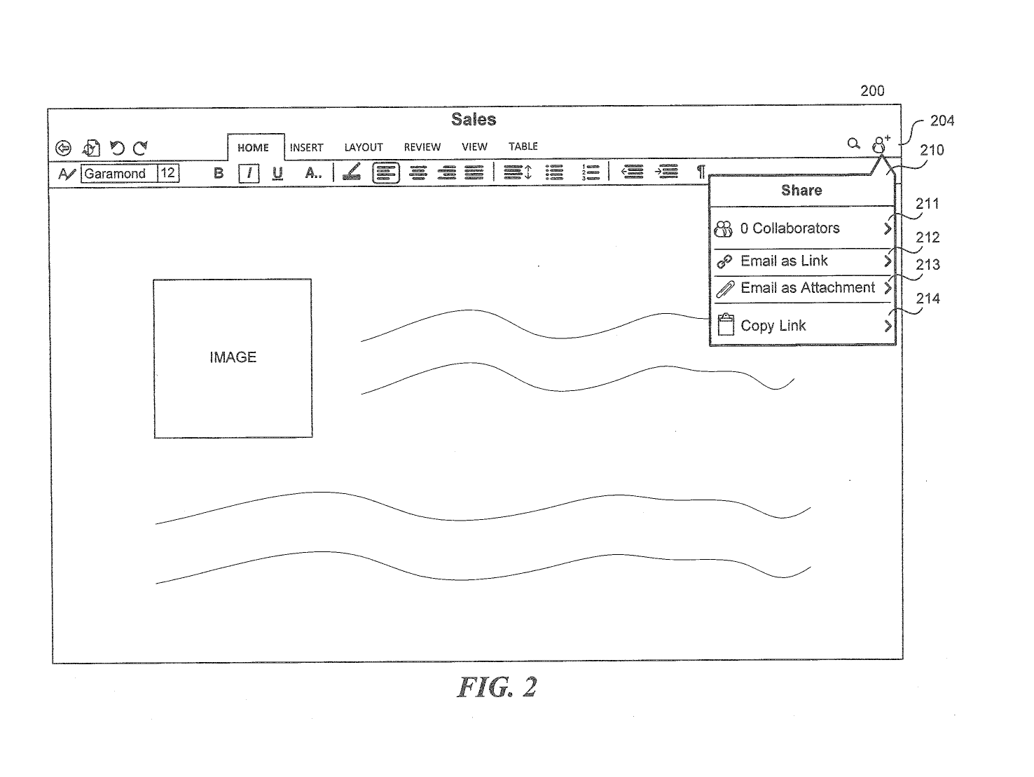

FIG. 2 is a display page that illustrates functionality provided when the share icon is selected in some embodiments. When the share icon 204 is selected, the collaboration icon system displays a collaboration dialog box 210. The collaboration dialog box 210 contains a share item 211 that shares the open document with a user, an email link item 212 that emails a link to the document, an email attachment item 213 that emails the document as an attachment, and a copy link item 214 that allows for copying the link to a clipboard.

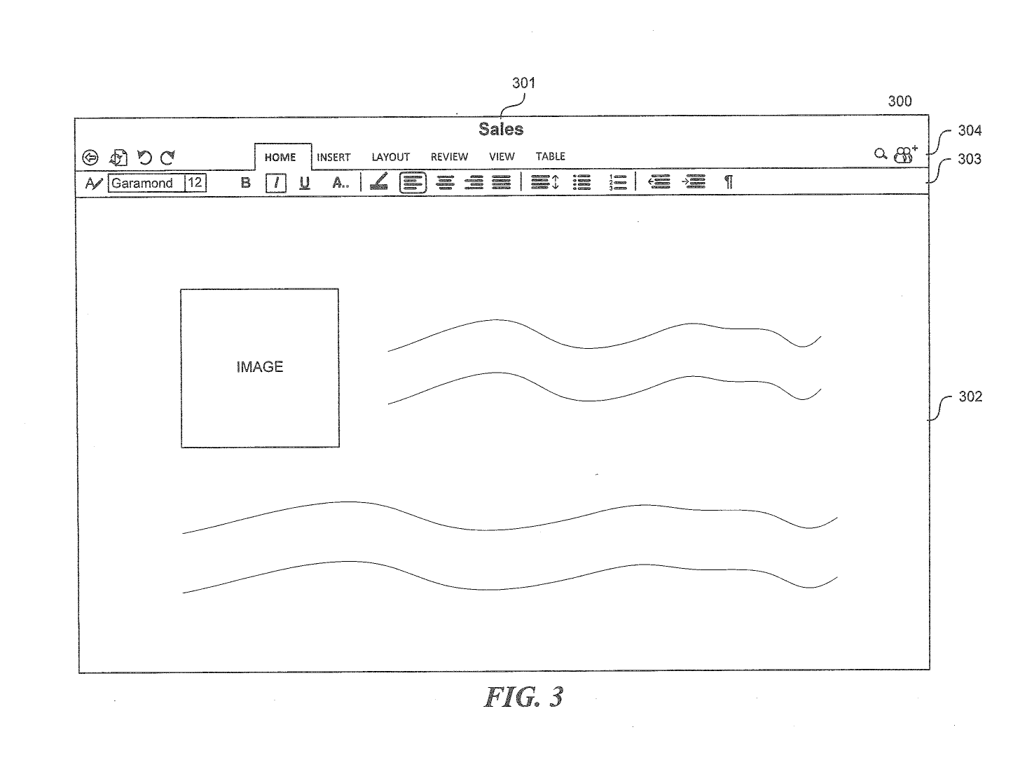

FIG. 3 is a display page that illustrates the display of a collaborators icon in some embodiments. A display page 300 includes a name area 301, a content area 302, a ribbon area 303, and a collaboration icon area 304. The collaboration icon area 304 currently displays a collaborators icon indicating that the currently open document has been shared with a collaborator, but there are not multiple editors. The collaborators icon is illustrated as multiple unshaded pawns with a plus sign indicating the number of collaborators.

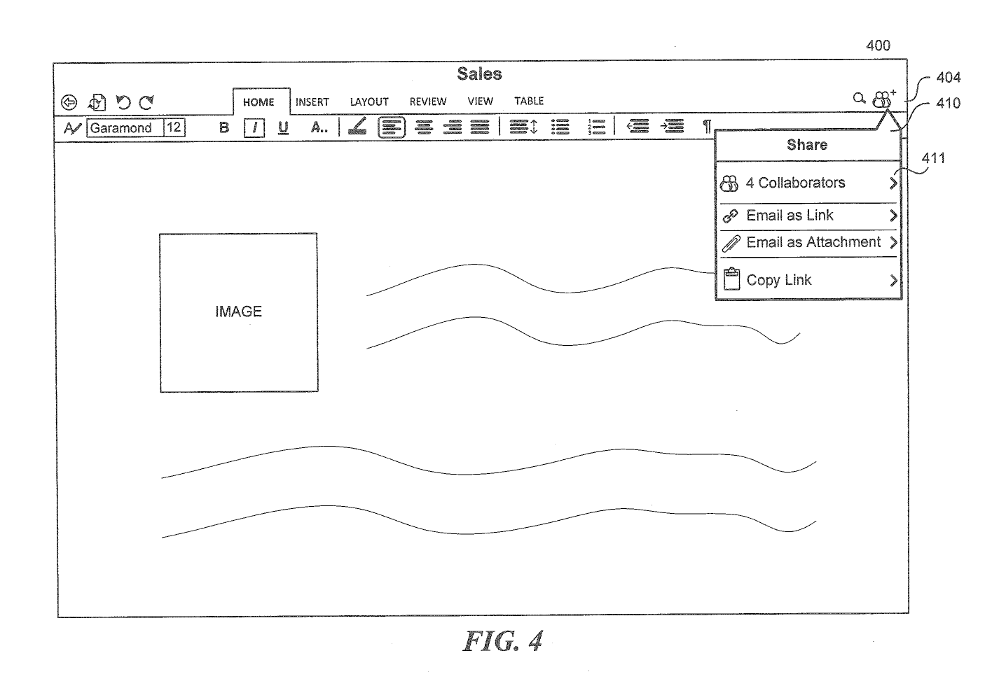

FIG. 4 is a display page that illustrates functionality provided when the collaborators icon is selected in some embodiments. When the collaborators icon 404 is selected, the collaboration icon system displays a collaboration dialog box 410. The collaboration dialog box contains a collaborators item 411 for accessing information about the collaborators. The information may include the names of the collaborators that when selected provide additional information about each collaborator.

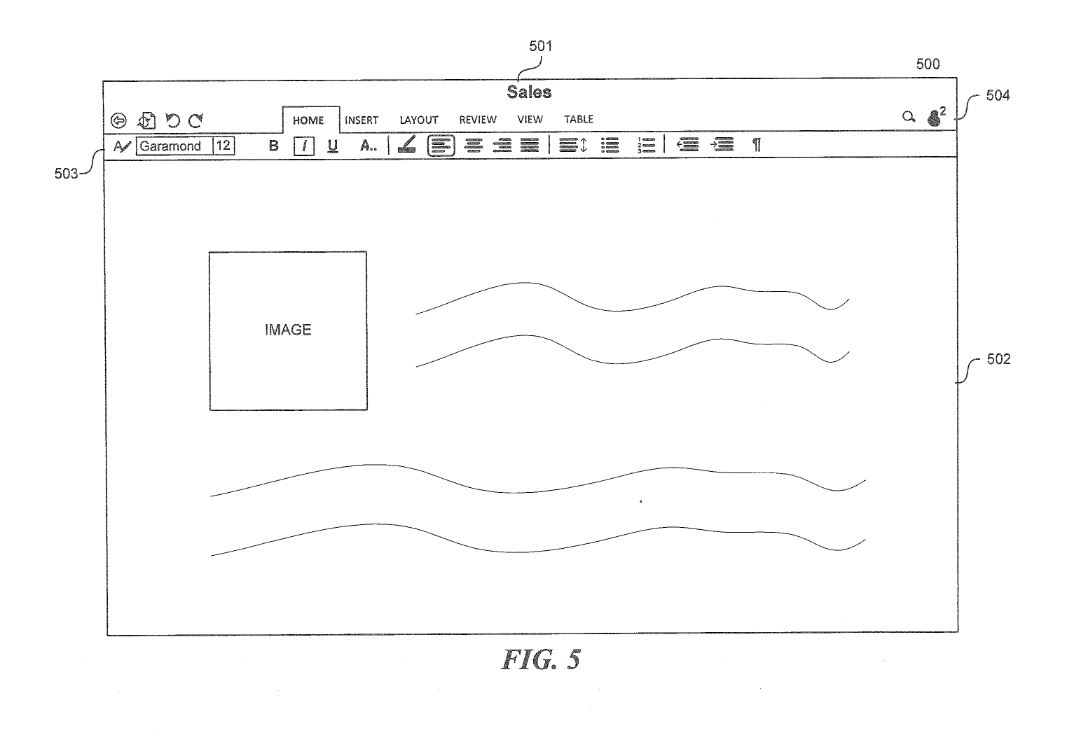

FIG. 5 is a display page that illustrates the display of an editors icon in some embodiments. A display page 500 includes a name area 501, a content area 502, a ribbon area 503, and a collaboration icon area 504. The collaboration icon area currently displays an editors icon indicating that the currently open document has multiple editors. The editors icon is illustrated as a shaded pawn with a number indicating the number of editors. The shading indicates that there are multiple editors. The editors icon may alternatively be illustrated by multiple shaded pawns.

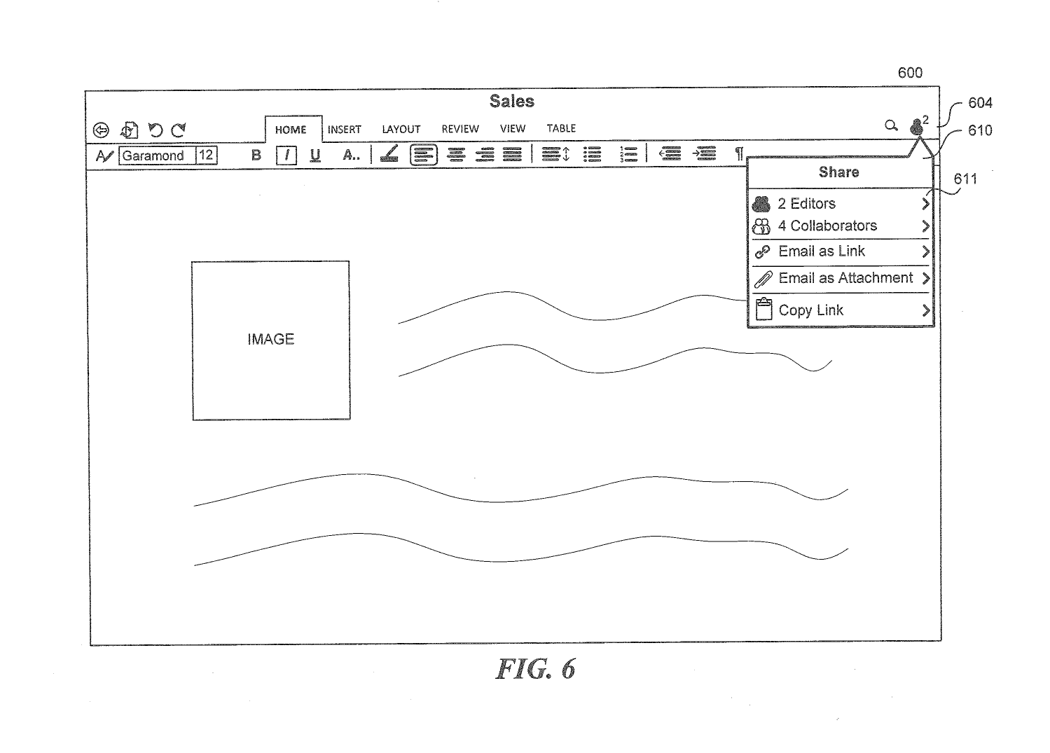

FIG. 6 is a display page that illustrates functionality provided when the editors icon is selected. When the editors icon 604 is selected, the collaboration icon system displays a collaboration dialog box 610. The collaboration dialog box contains items similar to the collaboration dialog box 410 except it also includes an editors item 611 (i.e., with multiple shaded pawns) for accessing information about the editors. The information may include the names of the editors that when selected provide additional information about each editor.

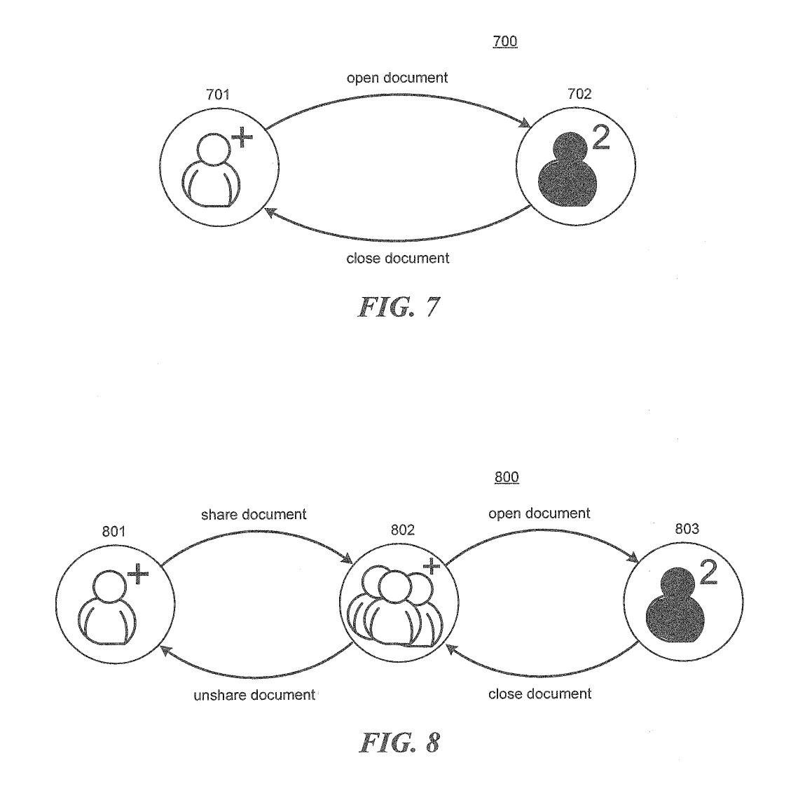

FIG. 7 illustrates a state diagram for a collaboration state that has two possible states in some embodiments. A state diagram 700 includes a circle 701 representing a no multiple editors state and a circle 702 representing a multiple editor state. Each circle contains an example of an icon that is displayed when in that state. The arrows indicate events that cause transitions between the states. When a document is initially open for editing, the document enters the no multiple editors state. When in the no multiple editors state, represented by circle 701, and another collaborator opens the document for editing, the collaboration state transitions to the multiple editors state and displays the icon illustrated in circle 702. If additional collaborators open the document and become editors, the document stays in the multiple editors state. If an editor closes the document becoming no longer an editor, the document stays in the multiple editors state unless that editor was the only editor left in which case the document transitions to the no multiple editors state. As collaborators open the document and editors close the document, the collaboration icon system modifies the number of editors displayed to reflect the current number of editors.

FIG. 8 illustrates a state diagram for a collaboration state that has three possible states in some embodiments. A state diagram 800 includes a circle 801 representing a no collaborators state, a circle 802 representing a collaborator states with no multiple editors, and a circle 803 representing a multiple editors state. Each circle contains an example of an icon that is displayed when in that state. The arrows indicate events that cause transition between the states. When a document is initially open for editing, the document enters the no collaborators state. When in the no collaborators state, represented by circle 801, and the user shares the document with another user, the collaboration state transitions to the collaborators with no multiple editors state, represented by circle 802. If a collaborator opens the document when in the collaborators with no multiple editors state, the collaboration state transitions to the multiple editors state represented by the circle 803. If additional collaborators open the document, becoming editors, the document stays in the multiple editors state. If an editor closes the document becoming no longer an editor, the document stays in the multiple editors state unless only one editor was left in which case the document transitions to the collaborators with no multiple editors state. If the sharing of the document with all collaborators has been revoked, the document transitions to the no collaborators state. As the document is shared with collaborators and the sharing is revoked, the collaboration icon system updates the number of collaborators displayed as part of the collaborators with no multiple editors state. As collaborators open the document and editors close the document, the collaboration icon system modifies the number of editors displayed as part of the multiple editors icon to reflect the current number of editors.

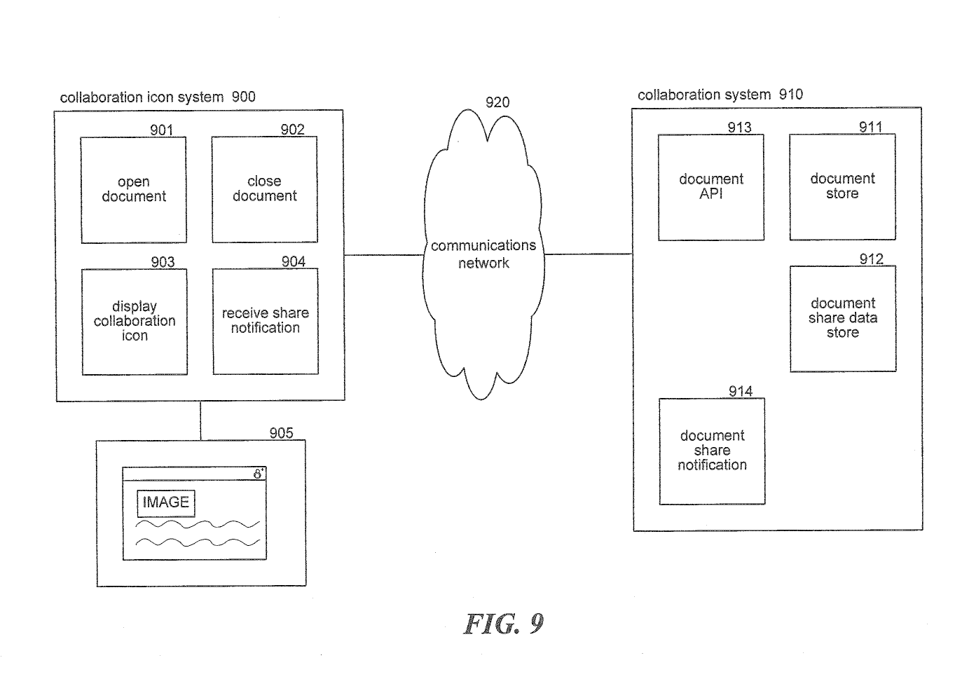

FIG. 9 is a block diagram that illustrates components of a collaboration icon system in some embodiments. A collaboration icon system 900 is connected to a collaboration system 910 via a communications network 920. The collaboration system includes a document store 911, a document share data store 912, a document API component 913, and a document share notification component 914. The document store is repository of the documents managed by the collaboration system. The document share data store is a repository of information relating to the sharing of the documents such as the identification of each collaborator and the identification of each collaborator that is currently an editor. The document API component provides an application programming interface for client devices connected to the collaboration system to access the documents of the document store and the share data of the document share data store. The document share notification component provides notifications to client devices related to the opening and closing of documents. For example, the collaboration system may provide a notification to a collaborator when another collaborator opens the document for editing and a notification to an editor when all other editors have closed the document.

The collaboration icon system includes an open document component 901, a close document component 902, a display collaboration icon component 903, and a receive share notification component 904. The collaboration icon system is connected to an output device 905, such as a touchscreen display. When a user indicates to open a document, the open document component retrieves the document from the document store, displays the content of the document and then invokes the display collaboration icon component to display the appropriate icon depending on the collaboration state of the document. The receive share notification components receive notification of changes in the collaboration state from the collaboration system and updates the collaboration icon. The close document component is invoked when the user closes the document and notifies the collaboration system, which in turn may generate a share notification that is distributed to any other editors of that document.

The computing devices and systems on which the collaboration icon system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touchscreens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the collaboration icon system. The data transmission media is used for transmitting data via transitory, propagating signals or carrier waves (e.g., electromagnetism) via a wired or wireless connection.

The collaboration icon system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the collaboration icon system may be implemented in hardware using, for example, an application-specific integrated circuit (“ASIC”).

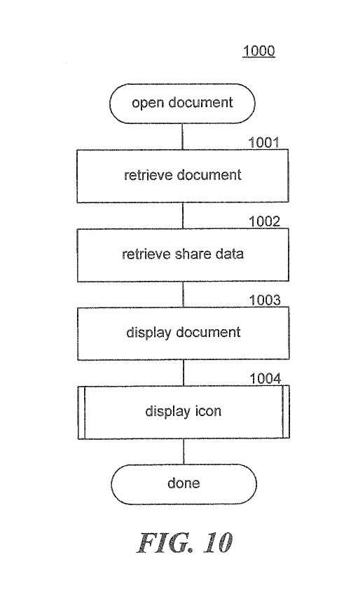

FIG. 10 is a flow diagram that illustrates the processing of an open document component of the collaboration icon system in some embodiments. An open document component 1000 is invoked when a collaborator opens a document and is passed a link to the document. The component opens the document and displays the appropriate collaboration icon. In block 1001, the component retrieves the document from the collaboration system. In block 1002, the component retrieves the share data for the document from the collaboration system. In block 1003, the component displays the content of the document. In block 1004, the component invokes the display collaboration icon component in order to display the collaboration icon and then completes. In response to the document being opened, the collaboration system may send a share notification to the editors of the document.

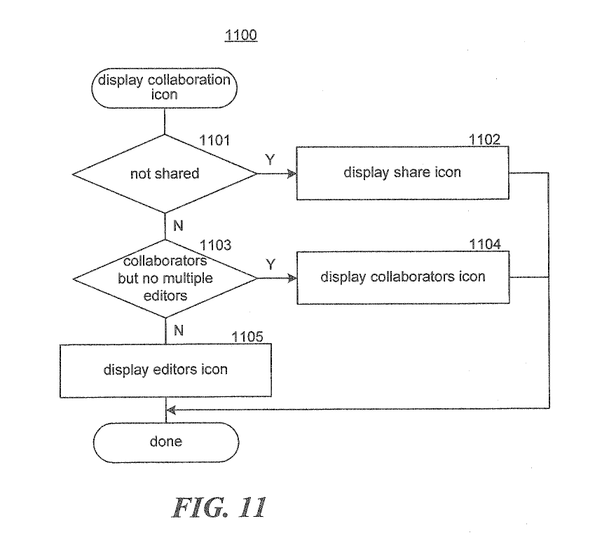

FIG. 11 is a flow diagram that illustrates the processing of a display collaboration icon of the collaboration icon system in some embodiments. A display collaboration icon component 1100 is invoked by the open document component and is passed an indication of the collaboration state. The component displays a collaboration icon based on the collaboration state. In decision block 1101, if the collaboration state is the not shared state, then the component continues at block 1102, else the component continues at block 1103. In block 1102, the component displays the share icon and then completes. In decision block 1103, if the collaboration state is the collaborators but no multiple editors state, then the component continues at block 1104, else the component continues at block 1105. In block 1104, the component displays the collaborators icon and then completes. In block 1105, the component displays the editors icon and then completes.

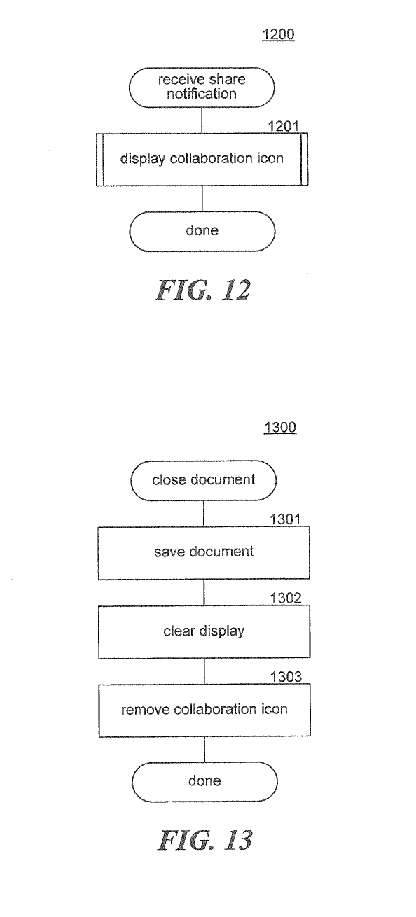

FIG. 12 is a flow diagram that illustrates the processing of a receive share notification component of the collaboration icon system in some embodiments. A receive collaboration notification component 1200 is invoked when a collaboration notification is received from the collaboration system. In block 1201, the component invokes the display collaboration icon component to update the collaboration icon based on the new collaboration state and then completes.

FIG. 13 is a flow diagram that illustrates the processing of a close document component of the collaboration icon system in some embodiments. A close document component 1300 is invoked when an editor indicates to close an open document. In block 1301, the component saves the document to the collaboration system. In block 1302, the component clears the content of the document on the display. In block 1303, the component removes the collaboration icon and then completes.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A computer-readable storage medium storing computer-executable instructions for controlling a computing device to indicate a collaboration state of a resource, the computer-executable instructions comprising instructions that:
determine the collaboration state of the resource;
when the collaboration state indicates that the resource does not have multiple editors, display a share icon; and
when the collaboration state indicates that the resource has multiple editors, display an editors icon;
wherein the share icon is selectable to support sharing the resource, wherein the editors icon is selectable to support sharing the resource and accessing information relating to the editors, and wherein the share icon and the editors icon provide indications of the collaboration state while the resource is being accessed.

2. The computer-readable storage medium of claim 1 further comprising instructions that, when the collaboration state changes from not having multiple editors to having multiple editors, replace the share icon with the editors icon.

3. The computer-readable storage medium of claim 1 further comprising instructions that, when the collaboration state changes from having multiple editors to not having multiple editors, replace the editors icon with the share icon.

4. The computer-readable storage medium of claim 1 wherein the editors icon includes an indication of the number of editors.

5. The computer-readable storage medium of claim 1 wherein the share icon is an unshaded pawn icon and the editors icon is a shaded pawn icon.

6. The computer-readable storage medium of claim 5 wherein the editors icon includes an indication of the number of editors.

7. The computer-readable storage medium of claim 5 wherein the share icon includes a plus sign as a suggestion that the share icon is selectable to support sharing the resource.

8. The computer-readable storage medium of claim 1 further comprising instructions that, when the collaboration state indicates that the resource does not have multiple editors, display a variation of the share icon to indicate whether the resource has been shared with a collaborator.

9. A computer-readable storage medium storing computer-executable instructions for controlling a computing device to indicate a collaboration state of a resource, the computer-executable instructions comprising instructions that:
determine the collaboration state of the resource;
when the collaboration state indicates that the resource is not shared, display a share icon;
when the collaboration state indicates that the resource is shared, but does not have multiple editors, display a collaborators icon;
when the collaboration state indicates that the resource has multiple editors, display an editors icon;
wherein the share icon and the collaborators icon are selectable to support sharing the resource, wherein the editors icon is selectable to support sharing the resource and accessing information relating to the editors, and wherein the share icon, the collaborators icon, and the editors icon provide an indications of the collaboration state while the resource is being accessed.

10. The computer-readable storage medium of claim 9 further comprising instructions that, when the collaboration state changes to a new collaboration state, replace the displayed icon with the icon for the new collaboration state.

11. The computer-readable storage medium of claim 9 wherein the editors icon includes an indication of the number of editors.

12. The computer-readable storage medium of claim 9 wherein the share icon is an unshaded pawn icon, the collaborators icon is an unshaded pawn icon with an indication that the resource is shared, and the editors icon is a shaded pawn icon.

13. The computer-readable storage medium of claim 12 wherein the collaborators icon includes an indication of the number of collaborators of the resource with and the editors icon includes an indication of the number of editors of the resource.

14. A method performed by a computing device for indicating to a user a collaboration state of an open document, the method comprising:
opening a document;
determining the collaboration state of the document, the collaboration state indicating whether the document has multiple editors and whether, an editor is a collaborator who currently has the document open for editing;
when the collaboration state indicates that the document does not have multiple editors,
displaying a share icon, the share icon being an unshaded pawn with a plus sign; and
when the share icon is selected, displaying an indication of a function for sharing the document with another user;
when the collaboration state indicates that the document has multiple editors,
displaying an editors icon, the editors icon being a shaded pawn with a number indicating the number of editors; and
when the editors icon is selected, displaying an indication of a function for sharing the document with another user and information relating to the multiple editors
wherein the share icon and the editors icon together provide a persistent indication of the collaboration state while the document is open.

15. The method of claim 14 further comprising, when the collaboration state changes from not having multiple editors to having multiple editors, replacing the share icon with the editors icon.

16. The method of claim 15 further comprising, when the collaboration state changes from having multiple editors to not having multiple editors, replacing the editors icon with the share icon.

17. The method of claim 14 wherein the information relating to the multiple editors includes an identification of the editors.

18. The method of claim 14 further including, when the collaboration state indicates that the resource does not have multiple editors, displaying a collaborators icon to indicate that the document has been shared with another user.

19. The method of claim 18 wherein the collaborators icon indicates the number of users the document is shared with.

20. The method of claim 14 wherein a pawn is an outline suggestive of a human bust.
